(19) United States
(12) Patent Application Publication
(10) Pub. No.: US 2026/0268375 A1
(43) Pub. Date: Sep. 10, 2026

(54) SYSTEMS AND METHODS FOR MANAGING DIGITAL CONTENT ACCESS AND ADVERTISEMENT DELIVERY

(71) Applicant: The People’s Internet Experiment, Inc., Marina Del Rey, CA (US)

(72) Inventors: Anthony Le, Los Angeles, CA (US); Eric Posen, Los Angeles, CA (US); Brian Luscombe, New York, NY (US); Ryan Hudson, Tujunga, CA (US)

(21) Appl. No.: 19/539,694

(22) Filed: Feb. 13, 2026

Related U.S. Application Data
(60) Provisional application No. 63/758,988, filed on Feb. 14, 2025.

(51) Int. Cl. G06Q 30/0241

(52) U.S. Cl. CPC G06Q 30/0277

(57) ABSTRACT

Disclosed are example embodiments of a computer-implemented method and system for delivering advertisements or other content while mitigating interference from extensions or other software enabling ad-blocking or content filtering. A user device requests advertisement content or other content associated with a webpage, and a backend system selects an advertisement content URL from a distributed plurality of cloud-hosted locations using a randomized, pseudorandomized, or obfuscated lookup function to prevent predictable blocking. The user device retrieves the content from the selected URL and renders it within the webpage using techniques that reduce inline script blocking or filtering. In some embodiments, the system detects the presence of multiple ad-blocking applications and prompts a user to resolve potential conflicts. In other embodiments, users may selectively accept advertisements based on dynamically determined compensation offers. The disclosed system improves reliability of digital content delivery while enhancing user control and resilience against software-based interference.

### CROSS-REFERENCE TO RELATED APPLICATIONS

This application claims priority to U.S. Provisional Patent Application No. 63/758,988, filed on Feb. 14, 2025, which is incorporated herein by reference in its entirety for all purposes.

### TECHNICAL FIELD

The present disclosure relates generally to digital content delivery and access management, and, more specifically, to systems and methods for mitigating interference from extensions or other software applications enabling ad-blocking, content-filtering, or the blocking or filtering items that otherwise would display to a user, incentivizing user engagement with advertisements, and/or resolving conflicts between multiple extensions or other software applications enabling ad-blocking, content-filtering, or the blocking or filtering items that otherwise would display to a user.

### BACKGROUND

Modern web-based systems frequently rely on dynamically loaded third-party content, including scripts, media, and other externally hosted resources, to enable functionality, personalization, analytics, and content presentation within webpages. Such content is commonly retrieved at runtime using network requests and executed within a user device's browser or application environment.

Software applications and extensions that block, filter, or modify network requests or script execution are increasingly deployed on user devices. These applications may prevent certain resources from loading, alter execution behavior, or remove rendered elements based on predefined rules, filter lists, script patterns, or domain-based techniques. While effective for their intended purpose, such interference mechanisms can disrupt expected execution flows and interfere with the reliable delivery and rendering of digital content.

As interference mechanisms become more sophisticated, content delivery systems may experience increased variability in resource accessibility, execution timing, and rendering behavior. In some cases, content is partially delivered, delayed, or rendered inconsistently across user devices, resulting in degraded system reliability, broken page elements, or unintended behavior that is difficult to predict or diagnose using conventional techniques.

Additionally, user devices may concurrently execute multiple extensions or software applications that perform overlapping or competing interference functions. The simultaneous operation of multiple blocking or filtering mechanisms can lead to conflicts, inconsistent behavior, or unexpected outcomes that differ from the behavior produced by any single application operating alone.

Accordingly, there is a need for improved systems and methods that enhance the reliability of digital content delivery in the presence of software-based interference, provide controlled mechanisms for authorizing content rendering, and detect or resolve conflicts arising from the concurrent operation of multiple interference-causing applications.

### SUMMARY

In example implementations, the disclosure describes multiple independent and related systems and methods for managing digital content delivery in the presence of software-based interference. These implementations include techniques for delivering advertisement content or other content while circumventing software-based interference that blocks or filters items otherwise presented at, output by, or made available via a user device; systems for dynamically compensating users based on authorized rendering of advertisement content or other content; and methods for identifying and resolving conflicts between multiple ad-blocking or content-filtering software components installed on a user device. The following paragraphs describe representative embodiments corresponding to these implementations.

Disclosed are example embodiments of a computer-implemented method for delivering advertisement content or other content while circumventing software-based interference. In an example embodiment, a user device receives a request for advertisement content or other content associated with, or to be displayed in connection with, a user's visit to a webpage. The method includes determining whether ad-blocking software is active on the user device by monitoring script execution or network request behavior. Based on this determination, the method includes selecting a URL from a distributed plurality of URLs stored on a cloud-based storage system using a randomized, pseudorandomized, obfuscated, or algorithmically generated lookup function. The user device retrieves the advertisement content or other content from the selected URL and renders the retrieved content within the webpage. The distributed plurality of URLs may be dynamically updated to reduce predictability and avoid detection by ad-blocking software.

Disclosed are example embodiments of a system for dynamically compensating users based on authorized rendering of advertisement content or other content. In an example embodiment, the system includes a user device configured to load a webpage containing an embedded advertisement content or other content script and a backend server communicatively coupled to the user device. The backend server determines a compensation offer based on a bidding process involving one or more advertisers and transmits the compensation offer to the user device. The user device provides an acceptance or rejection of the compensation offer. Based on the acceptance, the backend server authorizes rendering of the advertisement content or other content on the user device and updates a user compensation record to reflect the authorized rendering.

Disclosed are example embodiments of a computer-implemented method for identifying and resolving conflicts between multiple ad-blocking software components installed on a user device. In an example embodiment, the method includes detecting, using a browser-side script, whether advertisement content or other content is displayed despite the presence of one or more installed extensions or other software enabling ad-blocking, content-filtering, or blocking or filtering of items otherwise presented to a user. The method further includes querying a browser extension API or other software API to retrieve a list of active extensions installed on the user device and identifying, from the retrieved list, multiple extensions or other software enabling ad-blocking or content filtering that may be interfering with each other. A prompt is displayed to the user indicating that multiple such extensions or software components are detected and may be causing conflicts, and user input is received to either disable one or more conflicting extensions or maintain an existing configuration.

The features and advantages described in the specification are not all-inclusive. In particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the disclosed subject matter.

### BRIEF DESCRIPTION OF THE DRAWINGS

The foregoing summary, as well as the following detailed description, is better understood when read in conjunction with the accompanying drawings. The accompanying drawings, which are incorporated herein and form part of the specification, illustrate a plurality of embodiments and, together with the description, further serve to explain the principles involved and to enable a person skilled in the relevant art(s) to make and use the disclosed technologies.

FIG. 1 illustrates a system architecture including a user device, a backend server, and a cloud-based storage system for distributing advertisement content in accordance with the systems and methods described herein.

FIG. 2 is a flowchart depicting the process of avoiding adblockers by dynamically selecting and retrieving advertisement content from distributed cloud-hosted URLs in accordance with the systems and methods described herein.

FIG. 3 is a flowchart illustrating the Fair Ads incentive system, where a backend server determines a compensation offer, and a user device evaluates and accepts or rejects the offer in accordance with the systems and methods described herein.

FIG. 4 is a flowchart showing the process for detecting and resolving conflicts caused by multiple ad-blocking extensions by querying the browser API and prompting the user for action in accordance with the systems and methods described herein.

FIG. 5 is an example screengrab for detecting multiple ad blockers in accordance with the systems and methods described herein.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### DETAILED DESCRIPTION

The detailed description set forth below in connection with the appended drawings is intended as a description of configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Embodiments of the systems, methods, and devices described herein may have one or more of the following capabilities. For example, one embodiment of the systems, methods, and devices described herein may include

Overview

The present disclosure describes systems and methods for managing delivery and rendering of digital content in the presence of software-based interference on a user device. In example implementations, a user device and one or more backend components cooperate to (i) detect interference with script execution or network request behavior, (ii) select and retrieve advertisement content or other content from distributed locations using randomized, pseudorandomized, obfuscated, or algorithmically generated lookup mechanisms, and (iii) render the retrieved content within a webpage using techniques that reduce blocking or filtering.

In additional example implementations, the disclosure describes (i) systems that conditionally authorize content rendering based on user acceptance signals and backend processing and (ii) methods for identifying and resolving conflicts among multiple installed extensions or other software that perform blocking or filtering functions. These implementations may be deployed independently or in combination and may utilize distributed storage, dynamic updating of content locations, cryptographic techniques, and browser API interaction to improve reliability and predictability of content delivery and execution.

Avoiding Adblockers

In an example embodiment, the present system provides a computer-implemented method for delivering advertisement content while circumventing ad-blocking software by distributing ad-serving scripts across multiple cloud-hosted files and dynamically retrieving advertisements using an obfuscated lookup mechanism.

In an example embodiment, the process may begin when a user device requests advertisement content associated with a webpage. The system first determines whether an adblocker is active by executing a script on the user device that monitors script execution behaviors, network request patterns, or known blocking mechanisms. Specifically, the script may initiate requests to test domains known to be blocked by common adblockers and detect whether the response is modified or blocked.

In an example embodiment, when an adblocker is detected, the system selects an advertisement content URL from a distributed plurality of advertisement content locations stored on a cloud-based storage system. The URL selection may be based on a randomized lookup function designed to obfuscate the URL selection process, preventing adblockers from learning static patterns. The randomized (or pseudorandomized) selection process may utilize cryptographic hashing techniques, time-based keys, or dynamically changing session identifiers.

In some embodiments, selection of an advertisement content URL or other content URL from a distributed plurality of URLs is performed using a randomized or pseudorandomized lookup function incorporating cryptographic obfuscation techniques. The lookup function may be configured to produce unpredictable URL selection patterns to reduce the likelihood that ad-blocking software can identify or preemptively block specific content locations. In example implementations, the lookup function may incorporate one or more inputs including time-based values, session-specific identifiers associated with a user device, or outputs of a cryptographically secure pseudorandom number generator (CSPRNG), optionally combined with a secret key maintained by a backend server and updated periodically.

Once an advertisement content URL or other content URL is selected, the user device retrieves the corresponding content from the selected location and renders the content within a webpage. In some embodiments, retrieval may involve redundant or alternative network requests to multiple servers or hosting locations to mitigate domain-based blocking. Rendering may be performed using techniques that reduce inline script blocking or static filtering, including execution within an inline frame element, deferred injection after page load, or other dynamic rendering mechanisms. To further enhance ad delivery reliability, some embodiments may include a machine learning model trained to predict and adapt to ad-blocking software behaviors. The machine learning model may use real-time telemetry data to identify emerging ad-blocking techniques and adjust advertisement content delivery mechanisms accordingly.

Training Data Collection: The system may collect anonymized data from multiple user devices regarding blocked network requests, script execution failures, and hidden ad elements. This data is used to train the model to recognize common ad-blocking patterns.

Feature Extraction: The machine learning model may analyze key features such as HTTP response modifications, JavaScript execution anomalies, and user interaction patterns to determine whether an adblocker is active.

Adaptive URL Selection: Based on its prediction, the machine learning model may dynamically adjust the advertisement content URL selection algorithm to evade blocking attempts.

Continuous Learning: The model may be periodically retrained using newly collected data to ensure that it remains effective against evolving ad-blocking technologies.

Fair Ads Incentive System

In example embodiments, the disclosure describes systems for conditionally authorizing rendering of advertisement content or other content on a user device based on signals exchanged between the user device and a backend server. Authorization may be determined using backend processing that evaluates one or more conditions associated with a content request and generates an authorization response transmitted to the user device.

The system may include a user device that loads a webpage containing an embedded advertisement script. This script establishes a connection with a backend server, which determines an authorization parameter or compensation offer based on a selection process involving one or more content sources or campaigns.

The compensation determination process involves several substeps:

The backend server receives an advertisement request from a webpage on the user device.

The server queries a database of active advertising campaigns, retrieving details about available bids from advertisers.

In some embodiments, retrieving the advertisement content or other content may include the use of an intermediary script designed to dynamically load advertisement data after the webpage has fully rendered. This technique minimizes detection by ad-blocking software, which often scans initial page load elements to block advertisements before they are displayed.

Deferred Execution: The intermediary script may be executed only after a predefined delay or when triggered by a user interaction event, such as scrolling or clicking on a webpage element.

On-Demand Retrieval: Instead of embedding advertisement content directly in the HTML source, the intermediary script may retrieve the content dynamically from a backend server after the main page resources have finished loading.

Obfuscated Content Injection: The script may disguise advertisement retrieval as a general content request by randomizing the function calls and parameters used in the network request.

Execution within a Secure Context: In some embodiments, the intermediary script may be sandboxed within an internet frame or executed in a shadow DOM, further reducing visibility to ad-blocking extensions.

The backend server evaluates each bid, considering factors such as advertiser budget, user history, and ad targeting parameters.

The highest bid that meets predefined criteria may be selected as the compensation offer.

In an example embodiment, once the compensation offer is determined, the backend transmits the offer to the user device. The user device may evaluate the offer by comparing it against a preconfigured user-defined threshold stored e.g., locally or within a user account on the backend server. If the offer meets or exceeds the threshold, the user device accepts the offer, and the advertisement content may be displayed.

In an example embodiment, the system tracks user engagement with the advertisement to ensure fairness and prevent fraud. This tracking may include monitoring interaction events such as mouse hover duration, video playback completion, or click-based engagement. The backend server then verifies the tracking data, which updates the user's compensation record stored in a distributed ledger system to maintain transparency.

In an example embodiment, the system may also allow users to customize their advertising experience, selecting preferred advertisement categories or defining additional rules regarding which types of ads they are willing to engage with. Additionally, the compensation offer may be dynamically adjusted in real-time based on advertiser budgets and competing bids to maximize both user earnings and advertiser efficiency.

Multiple Adblockers Detection and Resolution

In an example embodiment, this system provides a computer-implemented method for detecting and resolving conflicts between multiple ad-blocking applications installed on a user device.

In an example embodiment, the method begins when an unexpected advertisement is displayed on a webpage despite the presence of one or more installed adblockers. This triggers a conflict detection routine that determines whether multiple adblockers are interfering with each other.

In some embodiments, the system may utilize a browser extension API or other software API to retrieve a list of active extensions installed on the user device. This information allows the system to identify ad-blocking extensions that may be interfering with each other, causing unintended conflicts.

Extension Enumeration: The system queries the browser API to obtain metadata about installed extensions, including their identifiers, permissions, and activity logs.

Conflict Analysis: Using a predefined database of known ad-blocking extensions, the system may compare the installed extensions against the database to determine whether multiple ad-blockers (ad-blocking software including software that blocks advertising, content-filtering software, or other interference-causing software that blocks, filters, modifies, delays, redirects, suppresses, or prevents retrieval, execution, display, rendering, or other presentation of advertisement content or other content, including software applications, extensions, plug-ins, add-ons, scripts, browser-based modules, client-side or server-side programs, network-level tools, operating system-level controls, or other ad blocking code) are active simultaneously.

User Prompting: If multiple ad-blockers are detected, the system may generate a user notification indicating that conflicts may be causing inconsistent ad behavior.

Automated Resolution: In some embodiments, users may configure the system to automatically disable conflicting ad-blocking extensions based on predefined preferences.

Conflict Data Logging: The system may record conflict occurrences in a cloud database to refine future ad-blocker detection and resolution strategies.

In an example embodiment, the conflict detection process may include:

Detecting an anomaly by analyzing whether a requested advertisement was partially blocked, fully blocked, or modified.

Querying the browser's extension API to retrieve a list of active extensions installed on the user device.

Filtering the list to identify ad-blocking extensions by comparing their extension IDs and metadata against a known database of adblockers.

In an example embodiment, once multiple adblockers are detected, the system displays a conflict resolution prompt to the user. This prompt notifies the user that multiple adblockers are installed and may be causing unexpected behavior. The prompt provides the user with one or more recommended actions, such as disabling specific adblockers that are known to cause conflicts.

In an example embodiment, when the user agrees to disable an adblocker, the system automatically modifies the browser settings to disable or remove the conflicting extension. Alternatively, if the user declines to disable an adblocker, the system logs the detected adblocker conflict in a cloud-based database for analytics and future optimization.

In an example embodiment, the system may also use historical data to determine which combinations of adblockers are most likely to cause conflicts, allowing for more intelligent recommendations. Additionally, the system may offer automated resolution settings, where users can preconfigure their preferences to automatically disable conflicting adblockers without requiring manual intervention.

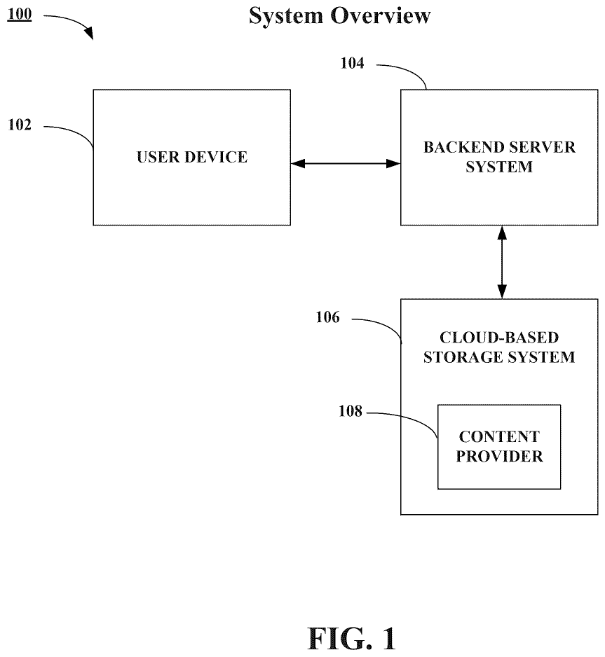

System Architecture (FIG. 1)

FIG. 1 illustrates a system architecture 100 including a user device 102, a backend server 104, and a cloud-based storage system 106 for distributing advertisement content in accordance with the systems and methods described herein. The figure illustrates an example system architecture for implementing the methods described herein. In an example embodiment, the system includes a user device 102, which may be a computer, tablet, smartphone, or other computing device capable of accessing web content through a web browser. The web browser on the user device 102 may be configured to execute scripts that enable interaction with backend systems and cloud-based storage. The user device 102 communicates with a backend server system 104, which may be responsible for managing advertisements, tracking user engagement, and processing user-defined incentive preferences.

In an example embodiment, the backend server system 104 interfaces with a cloud-based storage system 106 that hosts a large volume of ad-serving scripts distributed across multiple files. This distributed storage architecture ensures that adblockers cannot rely on predictable URL patterns to block ad-related content. Instead, the system dynamically selects URLs from the distributed storage locations based on randomized selection algorithms (or pseudorandomized selection algorithms), further obfuscated using cryptographic methods. This architecture prevents the ad delivery infrastructure from being easily detected and targeted by ad-blocking software.

In an example embodiment, when a user device 102 requests a webpage, the content provider 108 communicates with the backend server system 104 to determine the appropriate ad-serving strategy. The backend server system 104 retrieves ad-related scripts and content from cloud-based storage system 106 and sends it to the user device 102 for display. This dynamic and distributed approach represents a significant improvement over traditional methods, which often rely on static URLs that are easily identified and blocked by adblockers.

In an example embodiment, the system architecture 100 may dynamically select and retrieve advertisement content from distributed cloud-hosted URLs associated with the cloud-based storage system 106, making it more difficult for adblockers to predict and block ad-serving locations. The selection of an advertisement URL is performed using an obfuscated lookup function that may help ensure unpredictability in URL patterns. In some embodiments, this process may leverage a cryptographic hash function or a cipher-based mechanism that takes inputs such as the current date, session identifiers, or additional randomized (or pseudorandomized) variables to generate a dynamically changing URL known to the system but obfuscated to external detection. This may help ensure that ad delivery infrastructure remains resilient against static filtering techniques. The randomized (or pseudorandomized) selection process may prevent adblockers from recognizing and preemptively blocking specific domains, significantly increasing the robustness of ad-serving mechanisms.

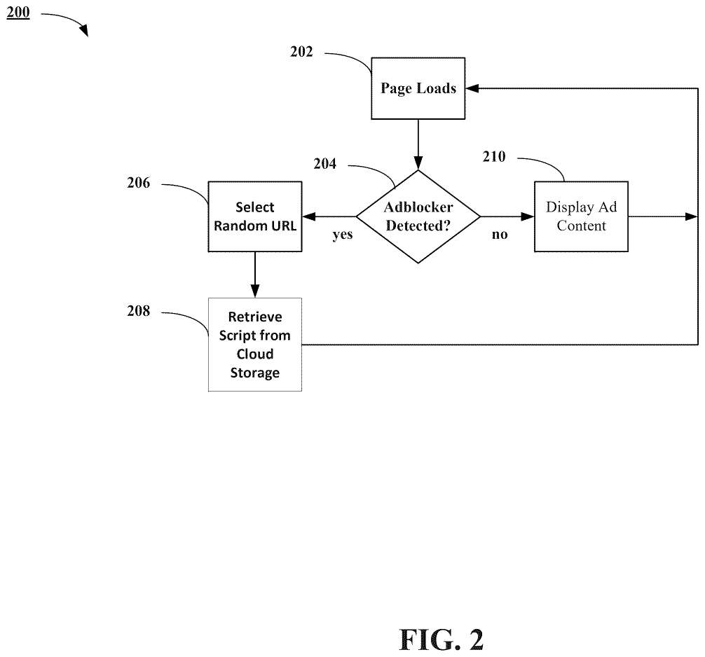

Avoiding Adblockers (FIG. 2)

FIG. 2 is a flowchart 200 depicting the process of avoiding adblockers by dynamically selecting and retrieving advertisement content from distributed cloud-hosted URLs in accordance with the systems and methods described herein. In an example embodiment, the process begins when a user device loads a webpage 202. During the initial page load, the system checks for the presence of adblockers 204. This detection may involve monitoring for known interference patterns, such as blocked JavaScript functions or network requests that fail due to adblocker filtering.

In an example embodiment, when an adblocker is detected, the system initiates a process to select a randomized (or pseudorandomized) URL from a pool of distributed ad-serving locations hosted in the cloud-based storage system 206. The selection of the URL may be performed dynamically, and the specific URL chosen for each ad request may be determined by an obfuscated lookup function that prevents predictable URL patterns. The ad-related script may then be retrieved from the selected URL and executed on the user device 208, allowing the ad content to be displayed. When an adblocker is not detected 204 the ad may simply be displayed 210.

In an example embodiment, by distributing ad-serving scripts across a large number of files and using randomized (or pseudorandomized) URL selection, the system makes it impractical for adblockers to target specific URLs without blocking large portions of unrelated content. This technical approach represents a tangible improvement over conventional ad delivery methods, which are easily circumvented by adblockers using static URL patterns.

In an example embodiment, the system may detect the presence of adblockers through multiple technical checks before selecting and retrieving advertisement content from distributed cloud-hosted URLs. Adblocker detection may involve monitoring script execution, network requests, and page modifications to identify interference.

The system may implement one or more of the following detection methods: (1) Attempting to connect to a known ad-serving domain and verifying whether the request is successfully processed or blocked on the client side. A failed connection may indicate that an adblocker is actively preventing access to the ad resource. (2) Checking whether the expected ad resource request reaches the intended server and returns the correct content. Some adblockers may redirect or modify responses rather than outright blocking them. The system may verify whether the received content matches the expected response, identifying potential interference. (3) Detecting hidden ad placements. Even if an adblocker blocks network requests, it may also hide or remove ad elements on a webpage. The system may inject a placeholder ad slot and check whether it has been automatically hidden, signaling adblocker activity. (4) Detecting script injections and unauthorized modifications. Adblockers may frequently modify webpage scripts or inject additional scripts to override standard ad behavior. The system may analyze script execution patterns, detect unexpected injections, or compare the rendered page structure against an unmodified baseline to determine if modifications have occurred. By leveraging these detection methods, the system may dynamically adapt its ad-serving strategy, ensuring consistent advertisement delivery despite active adblockers.

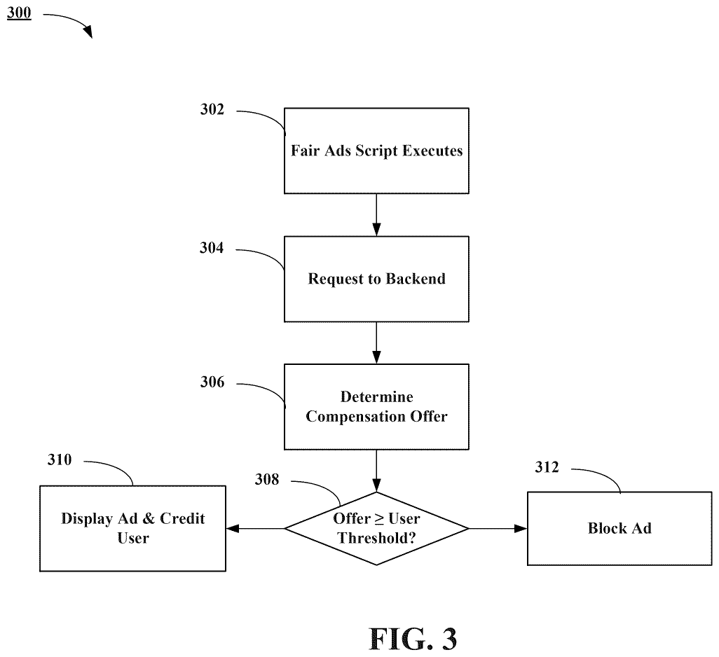

Fair Ads Incentive System (FIG. 3)

FIG. 3 is a flowchart 300 illustrating the Fair Ads incentive system, where a backend server determines a compensation offer, and a user device evaluates and accepts or rejects the offer in accordance with the systems and methods described herein. In an example, the operation of the Fair Ads incentive system, may enable publishers to bid for ad placement while allowing users to set minimum compensation thresholds for accepting ads. In an example embodiment, this system may be designed to align the interests of publishers and users by providing users with a financial incentive to allow ads, thereby increasing ad engagement while giving users control over their advertising experience.

In an example embodiment, when a user device loads a webpage, the Fair Ads script executes on the user device 302 and sends a request to the backend server to determine the compensation offer for displaying an advertisement 304. The backend server calculates the compensation offer based on factors such as the publisher's ad budget and the user's configured preferences 306. The user may specify a minimum threshold for accepting ads, such as a certain number of points or a percentage of the publisher's revenue.

The system compares the compensation offer to the user's threshold 308 in an example embodiment. If the offer meets or exceeds the user's threshold, the ad may be displayed, and the user may be awarded the agreed-upon compensation 310, which may take the form of points, credits, or other rewards. The ad may be blocked if the offer is below the user's threshold and no compensation is provided 312. This dynamic and user-configurable approach to ad engagement provides a significant improvement over conventional advertising models, which do not allow users to set their own compensation preferences.

In an example embodiment, the Fair Ads Incentive System may enable users to define a compensation threshold for allowing advertisements. This threshold may represent the minimum compensation a user is willing to accept in exchange for viewing ads. The backend server may determine compensation offers based on advertiser bids, user preferences, and predefined system parameters.

The user's threshold may be maintained on the backend server to ensure integrity and prevent manipulation. When an advertisement request is processed, the backend may transmit the threshold value to the user device for evaluation. While a user may attempt to alter the threshold locally, the backend server verifies the compensation calculation in a protected environment before awarding any points or credits. This may help ensure that fraudulent modifications on the user device do not affect compensation accuracy.

By implementing server-side verification and protected processing environments, the system may help ensure fair compensation, prevents tampering, and maintains advertiser trust while allowing users to personalize their ad experience.

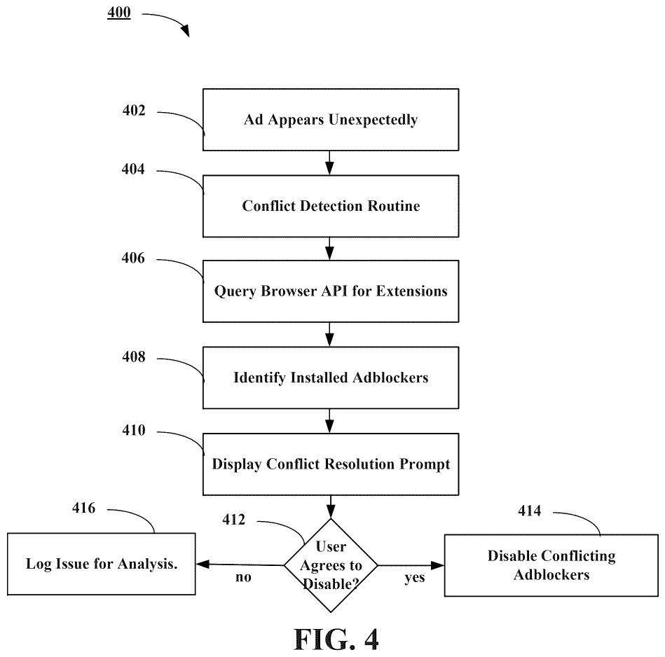

Multiple Adblockers Detection and Resolution (FIG. 4)

FIG. 4 is a flowchart 400 showing the process for detecting and resolving conflicts caused by multiple ad-blocking extensions by querying the browser API and prompting the user for action in accordance with the systems and methods described herein. The figure illustrates the process for detecting and resolving conflicts when multiple adblockers are installed on a user device. In an example embodiment, when an ad is displayed despite the presence of active adblockers 402, the system initiates a conflict detection routine to identify the cause of the unexpected behavior 404. This routine involves querying the browser API 406 to retrieve a list of installed extensions and filtering the list to identify active adblocker extensions 408.

In an example embodiment, when multiple adblockers are detected, the system displays a conflict resolution prompt to the user 410. The prompt informs the user that multiple adblockers may be interfering with each other and offers the option to disable conflicting adblockers. If the user consents 412, the system disables the identified adblockers to prevent further conflicts 414. If the user declines, the system logs the conflict for further analysis and potential improvements to future ad-serving strategies.

In an example embodiment, this automated conflict detection and resolution mechanism provides a practical solution to a common issue faced by users with multiple adblockers. By identifying and resolving conflicts in real-time, the system enhances the reliability and predictability of ad-blocking functionality.

In an example embodiment, this system may provide a computer-implemented method for detecting and resolving conflicts between multiple ad-blocking applications installed on a user device. When an ad is displayed despite active adblockers, the system may initiate a conflict detection routine to identify potential interference. This routine may involve querying the browser API to retrieve a list of installed extensions and filtering the list to identify active ad-blocking extensions.

Since all adblockers may interfere with each other, creating unexpected results and unpredictable environments, the system may disable them without prejudice rather than applying specific criteria for removal. This may help ensure that conflicts may be fully resolved, preventing inconsistent ad behavior caused by multiple overlapping adblockers.

Once multiple adblockers are detected, the system may display a conflict resolution prompt to the user, providing an option to disable conflicting adblockers. When the user consents, the system may modify browser settings to disable or remove the detected adblockers. When the user declines, the system may log the conflict for further analysis and future improvements in ad-blocker detection and resolution.

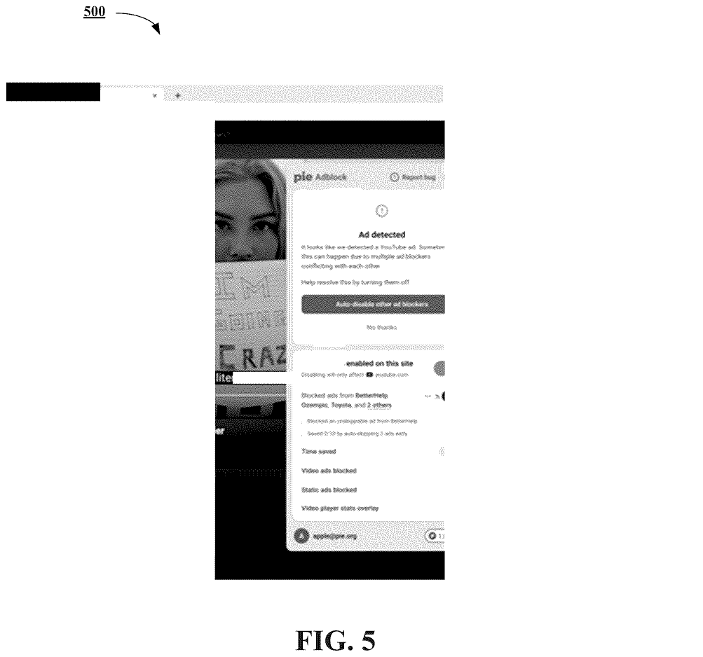

FIG. 5 is an example screengrab 500 for detecting multiple ad blockers in accordance with the systems and methods described herein. The figure illustrates an example webpage where an advertisement detection system has identified the presence of an active adblocker and responded by displaying an overlay in the form of a pie chart. The underlying webpage content remains visible but is partially obscured by the pie chart, which presents the user with a visual representation of the detected ad and corresponding engagement options. The system dynamically generates this overlay upon detecting that an advertisement was either blocked or partially rendered due to ad-blocking software. The pie chart may include interactive segments that allow the user to select different actions, such as temporarily whitelisting the site, enabling specific ads, or participating in the Fair Ads incentive system. This implementation ensures that users are informed of ad-blocking activity while allowing them to engage with advertising content in a controlled and incentivized manner.

One or more elements or aspects or steps, or any portion(s) thereof, from one or more of any of the systems and methods described herein may be combined with one or more elements or aspects or steps, or any portion(s) thereof, from one or more of any of the other systems and methods described herein and combinations thereof, to form one or more additional implementations and/or claims of the present disclosure.

One or more of the components, steps, features, and/or functions illustrated in the figures may be rearranged and/or combined into a single component, block, feature or function or embodied in several components, steps, or functions. Additional elements, components, steps, and/or functions may also be added without departing from the disclosure. The apparatus, devices, and/or components illustrated in the Figures may be configured to perform one or more of the methods, features, or steps described in the Figures. The algorithms described herein may also be efficiently implemented in software and/or embedded in hardware.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description are presented in terms of algorithms and symbolic representations of operations on data bits within a computer memory. These algorithmic descriptions and representations are the methods used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared or otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following disclosure, it is appreciated that throughout the disclosure terms such as “processing,” “computing,” “calculating,” “determining,” “displaying” or the like, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. It will be appreciated that a variety of programming languages may be used to implement the teachings of the invention as described herein.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats.

Furthermore, as will be apparent to one of ordinary skill in the relevant art, the modules, routines, features, attributes, methodologies and other aspects of the present invention can be implemented as software, hardware, firmware or any combination of the three. Also, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming.

Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A computer-implemented method for delivering advertisement content or other content while circumventing software-based interference that blocks or filters items otherwise presented at, output by, or made available via a user device, the method comprising:
receiving, at a user device, a request for advertisement content or other content associated with, or to be displayed in connection with a user's visit to, a webpage;
determining whether ad-blocking software is active on the user device by monitoring script execution or network request behavior;
selecting, based on a randomized, pseudorandomized, obfuscated, or algorithmically-generated lookup function, an URL from a distributed plurality of URLs stored on a cloud-based storage system;
retrieving, via the user device, the advertisement content or other content from the selected advertisement content URL or other content URL; and
rendering the retrieved advertisement content or other content within the webpage, wherein the distributed plurality of advertisement content URLs or other content URLs is dynamically updated to avoid detection by ad-blocking software.

2. The method of claim 1, wherein the determining step includes executing a browser-side script that detects blocked network requests associated with known ad-serving domains.

3. The method of claim 1, wherein the advertisement content URL or other content URL is selected using a cryptographic obfuscation function that changes based on at least one of a time-based key, a session identifier, a randomized index or pseudorandomized index.

4. The method of claim 1, wherein the distributed plurality of advertisement content URLs or other content URLs is hosted across multiple cloud service providers to prevent domain-based blocking by ad-blocking software.

5. The method of claim 1, wherein rendering the advertisement content or other content includes embedding the content within an inline frame element to avoid inline script blocking.

6. The method of claim 1, wherein retrieving the advertisement content or other content further includes inserting an intermediary script that dynamically loads advertisement data after the webpage has completed rendering.

7. The method of claim 1, wherein the randomized or pseudorandomized selection of the advertisement content URL or other content URL is performed using a machine learning model trained to predict the behavior of ad-blocking software, content-filtering software, or other software capable of blocking or filtering items that otherwise would display to a user.

8. A system for dynamically compensating users based on authorized rendering of advertisement content or other content, the system comprising:
a user device configured to load a webpage containing an embedded advertisement content or other content script;
a backend server communicatively coupled to the user device, the backend server configured to:
determine a compensation offer based on a bidding process involving one or more advertisers;
transmit the compensation offer to the user device;
receive an acceptance or rejection of the compensation offer from the user device; and
based on the acceptance, authorize the rendering of advertisement content or other content on the user device and update a user compensation record.

9. The system of claim 8, wherein the compensation offer is determined based on an auction mechanism that considers a user's historical engagement with advertisements or other content.

10. The system of claim 8, wherein the user device includes a browser extension configured to automatically accept compensation offers exceeding a predefined threshold set by the user.

11. The system of claim 8, wherein the backend server further includes a tracking module configured to verify ad engagement by monitoring whether the user interacted with the advertisement for a predetermined duration.

12. The system of claim 8, wherein the user compensation record is stored in a distributed ledger to prevent fraud and ensure transparency.

13. The system of claim 8, wherein the backend server allows the user to select preferred advertisement categories for a personalized ad experience.

14. The system of claim 8, wherein the compensation offer is adjusted in real-time based on an advertiser's budget constraints and the availability of competing bids.

15. A computer-implemented method for identifying and resolving conflicts between multiple ad-blocking software installed on a user device, the method comprising:
detecting, using a browser-side script, whether advertisement content or other content is displayed despite the presence of one or more installed extensions or other software enabling ad-blocking, content-filtering, or the blocking or filtering items that otherwise would display to a user;
querying a browser extension API or other software API to retrieve a list of active extensions installed on the user device;
identifying, from the retrieved list, multiple extensions or other software enabling ad-blocking, content-filtering, or the blocking or filtering items that otherwise would display to a user that may be interfering with each other;
displaying a prompt to the user indicating that multiple extensions or other software enabling ad-blocking, content-filtering, or the blocking or filtering items that otherwise would display to a user are detected and may be causing conflicts; and
receiving user input to either disable one or more conflicting extensions or other software enabling ad-blocking, content-filtering, or the blocking or filtering items that otherwise would display to a user, or maintain the existing configuration.

16. The method of claim 15, wherein the detecting step further includes analyzing network request logs to determine whether an advertisement content or other content request was blocked, partially blocked, or modified by different extensions or other software enabling ad-blocking, content-filtering, or the blocking or filtering items that otherwise would display to a user.

17. The method of claim 15, wherein the querying step further comprises retrieving metadata associated with each detected extension or other software enabling ad-blocking, content-filtering, or the blocking or filtering items that otherwise would display to a user to determine compatibility or known conflicts.

18. The method of claim 15, wherein the user prompt, includes a recommended action based on prior data indicating which combination of extensions or other software enabling ad-blocking, content-filtering, or the blocking or filtering items that otherwise would display to a user causes the least conflicts.

19. The method of claim 15, wherein the method further includes automatically disabling one or more conflicting extensions or other software enabling ad-blocking, content-filtering, or the blocking or filtering items that otherwise would display to a user based on a predefined user preference.

20. The method of claim 15, wherein the method further includes logging detected extension or other software enabling ad-blocking, content-filtering, or the blocking or filtering items that otherwise would display to a user conflict in a cloud-based database for analytics and future conflict resolution recommendations.
